(19) United States
(12) Patent Application Publication
(10) Pub. No.: US 2007/0050394 A1
(43) Pub. Date: Mar. 1, 2007

(54) Method and apparatus for automated database creation from Web Services Description Language (WSDL)

(76) Inventors: Merle D. Sterling, Austin, TX (US); Vincent C. Brunssen, Round Rock, TX (US); Robert B. Chumbley, Austin, TX (US)

Correspondence Address: IBM CORPORATION;INTELLECTUAL PROPERTY LAW, 11400 BURNET ROAD, AUSTIN, TX, 78758, US

(21) Appl. No.: 11/214,563

(22) Filed: Aug. 30, 2005

(51) Int. Cl. G06F 7/00

(52) U.S. Cl. 707/102

(57) ABSTRACT

In accordance with the teachings of the present invention, a tool is presented for automatically generating a database in a Web Services environment. A database is identified. A Web Services Description Language (WSDL) document associated with a Web Services is identified. The elements of the WSDL document are examined to determine the data types associated with the Web Service. Based on the data types, a database is automatically generated that is compliant with the WSDL document and the Web Service.

### BACKGROUND OF THE INVENTION

1. Field of the Invention

This invention relates to data management. Specifically, the present invention relates to database management.

2. Description of the Prior Art

Modern information networks include computers connected across a communication infrastructure. The computers often include databases that store information and the communication infrastructure serves as a vehicle for communicating the information. As such, the combination is considered an information network.

A variety of standards are currently in use in information networks. For example, on the Internet (i.e., World Wide Web or Web), Hypertext Markup Language (HTML) is used as a standard to define how information is displayed in a graphical user interface (GUI). Transmission Control Protocol/Internet Protocol (TCP/IP) is used as a standard to communicate information across the Internet. In addition, Web Services is a set of interface standards used to facilitate interoperability across networks.

Web Services may be defined as the programmatic interfaces used for application-to-application communication over the World Wide Web (Web). Conventional Web Services use databases for storing and retrieving information. Databases are a critical part of any information architecture and are particularly important in a Web Services architecture. However, there are a variety of database systems that are each based on different standards and formats. These database systems often have a variety of different tools that are used for database creation. For example, small-embedded databases may be created programmatically and then populated with tables using various standardized commands (i.e., such as SQL commands). More powerful database systems often require an administrator to create the database either manually or by running a script that contains standardized commands (i.e., SQL commands). Either way, the process can be cumbersome to users unfamiliar with the database they are targeting or users that are not skilled in database design or programming. The inability to easily implement databases in a Web Services environment limits the deployment of Web Services.

Thus, there is a need for a method of implementing databases. There is a need for a method of implementing a database in a Web Services environment.

### SUMMARY OF THE INVENTION

A method and apparatus is presented for implementing a database in a Web Services environment. Web Services are implemented using a Web Services Description Language (WSDL). In accordance with the teachings of the present invention, a WSDL document contains information about data types (i.e., schema). This information is used in a tool to create a database for deployment in a Web Services architecture. In one embodiment, the tool automatically generates a database suitable for saving/retrieving using the data types in a WSDL document.

In one embodiment, a database creation method, comprises the steps of examining a Web Services Description Language schema associated with a Web Service; and generating a database usable by the Web Service in response to examining the Web Services Description Language schema.

In a second embodiment, a method of processing information, comprises the steps of identifying Web Services Description Language elements associated with a Web Service, the Web Services Description Language elements having relationships between the Web Services Description Language elements; determining the relationships between the Web Services Description Language elements; and generating a database in response to determining the relationships between the Web services Description Language elements.

In a third embodiment, a computer program product comprises a computer useable medium including a computer readable program, wherein the computer readable program when executed on a computer causes the computer to identify Web Services Description Language elements associated with a Web Service, the Web Services Description Language elements having relationships between the Web Services Description Language elements; determine the relationships between the Web Services Description Language elements; and generate a database in response to determining the relationships between the Web services Description Language elements.

### BRIEF DESCRIPTION OF THE DRAWINGS

FIG. 1 displays one embodiment of a Web Services architecture implemented in accordance with the teachings of the present invention.

FIG. 2 displays a flow diagram detailing a method of generating a database in a Web Services environment.

FIG. 3 displays a computer implementing the teachings of the present invention.

### DESCRIPTION OF THE INVENTION

While the present invention is described herein with reference to illustrative embodiments for particular applications, it should be understood that the invention is not limited thereto. Those having ordinary skill in the art and access to the teachings provided herein will recognize additional modifications, applications, and embodiments within the scope thereof and additional fields in which the present invention would be of significant utility.

In one embodiment of the present invention, Web Services, as promulgated in the World Wide Web Consortium (W3C), Working Draft 14, November 2002 (w3.org/TR/2002/WD-ws-arch-20021114), are implemented. Web Services provide a standard means of communication among different software applications running on a variety of platforms and/or frameworks. Web Services may be implemented with Extensible Markup Language (XML) based standards. Selected Web Services related standards and components include Simple Object Access Protocol (SOAP), SOAP Version 1.2 Part 1: MessagingFramework W3C Candidate Recommendation 19, December 2002 (w3.org/TR/soap12-part1/); Web Services Description Language (WSDL), Web Services Description Language (WSDL) Version 1.2 W3C Working Draft 24, January 2003 (w3.org/TR/wsdl12/); Universal Description Discovery and Integration Web Services (UDDI) Version 3.0 Published Specification, 19 Jul. 2002, (uddi.org (v3.00-published-20020719)); Hypertext Transfer Protocol (HTTP)—HTTP 1.1, IETF RFC 2616, 1999; etc.

Web Services are typically based on XML. SOAP is an XML-based protocol for exchanging and communicating information between computers. UDDI is a directory for registering and finding Web Services. WSDL describes how one software system can connect and utilize the services of another software system over the Internet. In the present invention, a schema in a WSDL document is used by a software tool to generate a database. In one embodiment, the software tool is implemented with a software development environment. The software development environment performs a method that processes information in the WSDL document. The WSDL document is used to generate a database for deployment in a Web Services architecture.

In one embodiment of the present invention, the WSDL documents perform three functions. WSDL documents (1) identify the contents and data types of messages; (2) define the operations performed on messages; and (3) identify the protocol used for transporting and exchanging messages with other operations over the network. As such, the WSDL document provides the descriptions and the definitions (i.e., schema) necessary to perform Web Services. In one embodiment of the present invention, the WSDL document, as defined by the W3C, includes service interface definitions and service implementation definitions. The service interface definitions allow common industry standard service types to be defined and implemented by multiple service implementers. The service implementation definition describes how a service interface is implemented by a given service provider.

A WSDL document includes elements that define the characteristics and the capabilities of a Web Services. It should be appreciated that although WSDL is described as being implemented in a document, WSDL may be stored in a memory or WSDL may be implemented as part of a communication data stream communicated across a network. As such, information that is stored in a memory, stored in a document, communicated as a signal or datastream may be WSDL-compliant information.

A WSDL document includes WSDL elements (i.e., abstract definitions), such as “message”, “portType”, “operation”, and “type.” The WSDL document also includes WSDL elements (i.e., concrete definitions), such as “binding”, “port”, and “service.” The abstract definitions define general concepts that can apply to more than one instance. The concrete definitions are examples that apply to real interactions. The “message” WSDL element provides a definition of a message that is communicated. The “portType” WSDL element defines the service interface of the operations that the Web Services support. The “operation” WSDL element describes an action provided by the Web services. The “operation” WSDL element is a child of the PortType. The “type” WSDL element provides a definition for the data types that messages, such as SOAP messages contain. The “bindings” WSDL element specifies the protocols by which nodes transport messages for data encoding. The “port” WSDL element specifies the address for a particular binding. The binding is a sub-element of the “Service” WSDL element. The “service” WSDL element specifies the location of the Universal Resource Locator (URL) of the Web Service on a server.

It should be appreciated that while a specific implementation of Web Services will be described and discussed in the present invention, variations of this implementation as promulgated by the W3C are still within the scope of the present invention. Further, consistent with all standards, various versions of the foregoing standards will be promulgated and distributed in the future. The method and apparatus of the present invention is applicable to the underlying model and architecture of the Web Services framework and is, therefore, within the scope of future versions of the Web Services standard.

In addition to Web Services technology, the method and apparatus of the present invention utilizes a number of different technology standards and application development environments. For example, databases may be implemented with Sequence Query Language (SQL). Application development environments, such as a Java developers environment or a Websphere Studio Application Developer (WSAD) environment, may be used to implement the teachings of the present invention. However, it should be appreciated that the scope of the invention is independent of the specific application development environment that may be used.

The application development environment is considered a database development tool. A WSDL schema associated with a web service is identified. The WSDL schema includes WSDL elements. Using the WSDL elements, the application development environment is operated to generate a database.

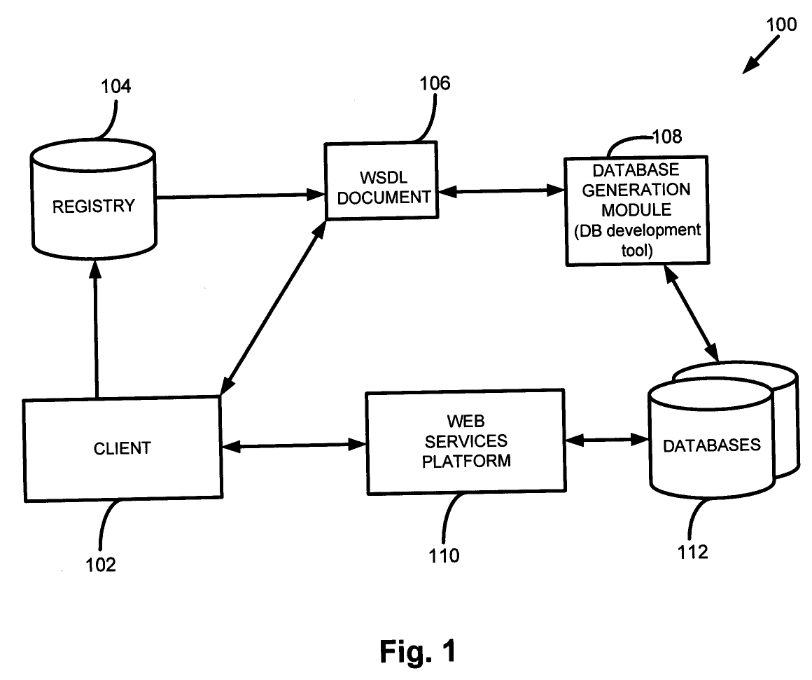

FIG. 1 displays one embodiment of a Web Services architecture 100 implemented in accordance with the teachings of the present invention. A client is shown at 102. The client 102 is capable of implementing methods (i.e., performing process steps). The client 102 may be implemented in hardware, software, or a combination of hardware and software. In one embodiment of the present invention, the client 102 is a computer operating under the direction of software.

The client 102 is in communication with a registry 104. The registry 104 is used to advertise Web Services. The registry 104 stores the location of Web Services on the network. For example, the registry 104 may store the Universal Resource Locator (URL) locations of various Web Services. Both the client 102 and the registry 104 communicate with a WSDL document 106. The client 102 is in communication with a Web Services platform 110. The Web Services platform 110 stores methods that may be initiated by the client 102. In one embodiment of the present invention, the Web Services platform 110 may be a server platform. The Web Services platform 110 is in communication with a database 112. The database 112 may include XML-compliant data or non-XML-compliant data (i.e., legacy data). In one embodiment of the present invention, the database generation module (i.e., database development tool) 108 interfaces with the WSDL document 106 to generate the database 112.

Each of the communication pathways between the network components, such as the client 102, the registry 104, the WSDL document 106, database generation module 108, the database 112, may each occur across a single network. In an alternate embodiment of the present invention, each component may communicate across separate or integrated networks. For example, the Web Services architecture 100 may be implemented in a packet-switched network, a circuit-switched network, etc.

During operation, the client 102 queries the registry 104 to locate a specific Web Service, such as a service that acquires data (i.e., legacy, non-XML-compliant). The registry 104 refers the client 102 to the WSDL document 106. The client 102 accesses the WSDL document 106. The WSDL document 106 provides data to enable the client 102 to communicate with the Web Services platform 110. The client 102 sends a message request, such as a SOAP message request, an HTTP message request, etc., to the Web Services platform 110. In response to the request, the Web Services platform 110 is able to query the database 112. The Web Services platform 110 then returns a message response, which includes data (i.e., legacy, non-XML-compliant, non-compliant) to the client 102.

In one embodiment, the WSDL document is created with an application development environment (i.e., tool) such as Java2WSDL development environment or a WSAD development environment. The database generation module 108 may then interface with the WSDL document 106 and generate a database 112. Alternatively, the database generation module 108 may be integrated with the WSDL generation and database 112 may be created as soon as the WSDL elements have been defined in the WSDL document 106.

```
  An example service will describe operations:
  public class AddressBook
  {
  private ArrayList contacts; // 0 or more Contacts
  public addContact(Contact c) { //insert contact into database}
  public removeContact(Contact c) { //delete contact from database}
  public Contact findContact(String contactName) {// ‘select’
contact from database}
  }
  public class Contact
  {
  private String name;
  private ArrayList emailAddress; // 0 or more String email addresses
  }
```

A simple database schema that would suffice for this service includes: table Contact: column1:(primarkyKey) contactID, column2:VARCHAR name table Email: column1:(primary key) emailID, column2 (foreign key of Contact) contactID, column3: VARCHAR emailaddr. When a WSDL document 106 is generated for this service, it would define a service name of AddressBookService, operations for addContact, removeContact, and findContact as well as a schema (i.e., wsdl:types) that defines the Contact type that is passed to and from the methods of a Web Service.

A WSDL generated for the AddressBookService is implemented as follows:

<?xml version=“1.0” encoding=“UTF-8”?>

| | |
|---|---|
| <wsdl:definitions | targetNamespace=“http://addressbook.ibm.com” |

xmlns:impl=“http://addressbook.ibm.com”
xmlns:intf=“http://addressbook.ibm.com”
xmlns:wsdl=“http://schemas.xmlsoap.org/wsdl/”
xmlns:wsdlsoap=“http://schemas.xmlsoap.org/wsdl/soap/”
xmlns:wsi=“http://ws-i.org/profiles/basic/1.1/xsd”
xmlns:xsd=“http://www.w3.org/2001/XMLSchema”>
<wsdl:types>
<schema targetNamespace=“http://addressbook.ibm.com”
xmlns=“http://www.w3.org/2001/XMLSchema”
xmlns:impl=“http://addressbook.ibm.com”
xmlns:intf=“http://addressbook.ibm.com”
xmlns:wsdl=“http://schemas.xmlsoap.org/wsdl/”
xmlns:xsd=“http://www.w3.org/2001/XMLSchema”>
<complexType name=“Contact”>
<sequence/>
</complexType>
<element name=“removeContactResponse”>
<complexType>
<sequence/>
</complexType>
</element>
<element name=“addContact”>
<complexType>
<sequence>
<element name=“c” nillable=“true”
type=“impl:Contact”/>
</sequence>
</complexType>
</element>
<element name=“addContactResponse”>
<complexType>
<sequence/>
</complexType>
</element>
<element name=“findContact”>
<complexType>
<sequence>
<element name=“contactName” nillable=“true”
type=“xsd:string”/>
</sequence>
</complexType>
</element>
<element name=“findContactResponse”>
<complexType>
<sequence>
<element name=“findContactReturn”
nillable=“true” type=“impl:Contact”/>
</sequence>
</complexType>
</element>
<element name=“removeContact”>
<complexType>
<sequence>
<element name=“c” nillable=“true”
type=“impl:Contact”/>
</sequence>
</complexType>
</element>
</schema>
</wsdl:types>
<wsdl:message name=“findContactResponse”>
<wsdl:part element=“impl:findContactResponse”
name=“parameters”/>
</wsdl:message>
<wsdl:message name=“removeContactRequest”>
<wsdl:part element=“impl:removeContact”
name=“parameters”/>
</wsdl:message>
<wsdl:message name=“addContactRequest”>
<wsdl:part element=“impl:addContact”
name=“parameters”/>
</wsdl:message>
<wsdl:message name=“findContactRequest”>
<wsdl:part element=“impl:findContact”
name=“parameters”/>
</wsdl:message>
<wsdl:message name=“addContactResponse”>
<wsdl:part element=“impl:addContactResponse”
name=“parameters”/>
</wsdl:message>
<wsdl: message name=“removeContactResponse”>
<wsdl:part element=“impl:removeContactResponse”
name=“parameters”/>
</wsdl:message>
<wsdl:portType name=“AddressBook”>
<wsdl:operation name=“removeContact”>
<wsdl:input message=“impl:removeContactRequest”
name=“removeContactRequest”/>
<wsdl:output message=“impl:removeContactResponse”
name=“removeContactResponse”/>
</wsdl:operation>
<wsdl:operation name=“addContact”>
<wsdl:input message=“impl:addContactRequest”
name=“addContactRequest”/>
<wsdl:output message=“impl:addContactResponse”
name=“addContactResponse”/>
</wsdl:operation>
<wsdl:operation name=“findContact”>
<wsdl:input message=“impl:findContactRequest”
name=“findContactRequest”/>
<wsdl:output message=“impl:findContactResponse”
name=“findContactResponse”/>
</wsdl:operation>
</wsdl:portType>
<wsdl:binding name=“AddressBookSoapBinding”
type=“impl:AddressBook”>
<wsdlsoap:binding style=“document”
transport=“http://schemas.xmlsoap.org/soap/http”/>
<wsdl:operation name=“removeContact”>
<wsdlsoap:operation soapAction=“”/>
<wsdl:input name=“removeContactRequest”>
<wsdlsoap:body use=“literal”/>
</wsdl:input>
<wsdl:output name=“removeContactResponse”>
<wsdlsoap:body use=“literal”/>
</wsdl:output>
</wsdl:operation>
<wsdl:operation name=“addContact”>
<wsdlsoap:operation soapAction=“”/>
<wsdl:input name=“addContactRequest”>
<wsdlsoap:body use=“literal”/>
</wsdl:input>
<wsdl:output name=“addContactResponse”>
<wsdlsoap:body use=“literal”/>
</wsdl:output>
</wsdl:operation>
<wsdl:operation name=“findContact”>
<wsdlsoap:operation soapAction=“”/>
<wsdl:input name=“findContactRequest”>
<wsdlsoap:body use=“literal”/>
</wsdl:input>
<wsdl:output name=“findContactResponse”>
<wsdlsoap:body use=“literal”/>
</wsdl:output>
</wsdl:operation>
</wsdl:binding>
<wsdl:service name=“AddressBookService”>
<wsdl:port binding=“impl:AddressBookSoapBinding”
name=“AddressBook”>
<wsdlsoap:address
location=“http://localhost:9080/AddressBook/services/AddressBook”/>
</wsdl:port>
</wsdl:service>
</wsdl:definitions>

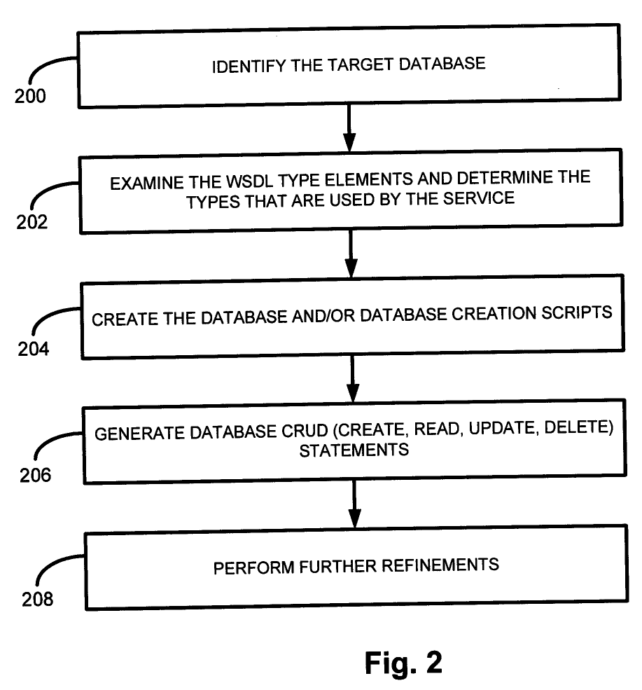

FIG. 2 displays a flow diagram detailing a method of generating a database in a Web Services environment. FIG. 2 will be discussed in conjunction with FIG. 1. At step 200, a target database 112 is identified. The DB generation module 108 allows the user to specify the target database 112. This can be via a user interface by providing a list of databases that the DB generation module 108 knows how to create and for which it can generate the appropriate SQL statements to create the tables, define indexes, etc. The user may provide a name of the database. In one embodiment, the DB generation module 108 will initially propose a name that matches the name of the service, but the user may change it to anything that meets the criteria of the chosen database 112 (naming convention, length, etc.). Based on the chosen target database 112, the DB generation module 108 loads its classes that contain the logic to create the database 112 and its tables, Java to DB type mappings, etc. Advanced users may extend the DB generation module 108 to work with other databases by writing their own classes that conform to the interface specified by the DB generation module 108.

As step 202, the WSDL document 106 is examined. In one embodiment, the wsdl:types element(s) is examined to determine the “types” that are used by the service. Using the foregoing example, this step would identify ‘Contact’ as a type that needs to be represented as a database table. It would recognize the one-to-many relationship between Contact and EmailAddress (due to the fact that the type of emailAddress is ArrayList which is a container type) and, thus, propose two tables in a one-to-many relationship: Contact and EmailAddress. The user may accept these names or provide alternative names, subject to the rules of the target database 112. The DB generation module 108 may then propose field names for each table, based on the fields within which each type it discovered, and allows the user to specify relationships: (i.e., 2a. Contact class—String ‘name’ can be mapped to a database column of type CHAR(N) or VARCHAR). The user is asked whether this column is sufficiently unique to be used as a primary key. If yes, it will be set as the primary key; if not, the user may indicate that the tool should generate a surrogate key (using a function specific to the target database 112, such as generate_hex_unique, or by generating a unique user identification). If the user has not identified a suitable primary key after all fields have been identified, the DB generation module 108 will automatically generate the surrogate key. For this particular example, ‘name’ is not likely to be unique and, thus, the use of a surrogate key would be required (identified as contactID).

In the contact class—ArrayList ‘emailAddress’—Having identified the fact that emailAddress is in a one-to-many relationship with Contact, the DB generation module 108 will propose column names for the EmailAddress table. The String emailAddress will be mapped to a CHAR or VARCHAR and again the user will have the option of specifying a primary key for this table.

The proper constraints will be added to enforce referential integrity between the Contact and EmailAddress tables. Check constraints may also be added to constrain the values within a column to a particular range, as defined in the WSDL. Using the foregoing example schema for the AddressBook, the SQL statements to create the tables, with the appropriate constraints to ensure referential integrity (i.e., primary key, foreign key, not null) may be implemented as follows:

create table Contact (
contactID INT PRIMARY KEY NOT NULL,
name VARCHAR(30)
);
create table Email (
emailID PRIMARY KEY NOT NULL,
contactID INT FOREIGN KEY REFERENCES Contact(contactID),
emailaddr VARCHAR(50)
).

As step, 204, a database or a database script is created. Depending on the target database 112, the DB generation module 108 may either create the database 112 directly or generate an SQL script/Java class to do so. For embedded databases that can be created programmatically, the DB generation module 108 can generate a simple Java class to create the database by appending “;create=true” to the end of the Java based URL.

In one embodiment, the user is given the option of specifying where to create the database for file system based databases. For more complex databases that usually require an administrator to create the database, it may generate a script to do so or a small Java class that invokes the database system's native administration application programmer interface (API) to create a new database. After the database 112 is created, the tables and constraints are created as well—again either using a script if the target database 112 supports it or programmatically via an automatically generated Java class. The tool may invoke the generated scripts upon completion or allow the user to invoke them manually later. The scripts and/or Java classes may be saved or discarded per user preference.

At step 206 basic Create, Read, Update, Delete (CRUD) statements are generated. The DB generation module 108 can generate the basic CRUD statements or modify the original Java bean from which the WSDL document was created. For simple insert, update, delete statements, this is a major time-saver; for more advanced select statements, the user may wish to modify the generated SQL, but for an unsophisticated end user, even the most basic select statements will work adequately.

As step 208, further refinements are performed. The database generation module 108 could also be used as part of the Web Services deployment. With minor additions to the deployment descriptor format, one could have the DB generation module 108 create the database 112 at deployment time or alternatively, create the database 112 prior to deployment and populate it with correct database schema at the time of deployment.

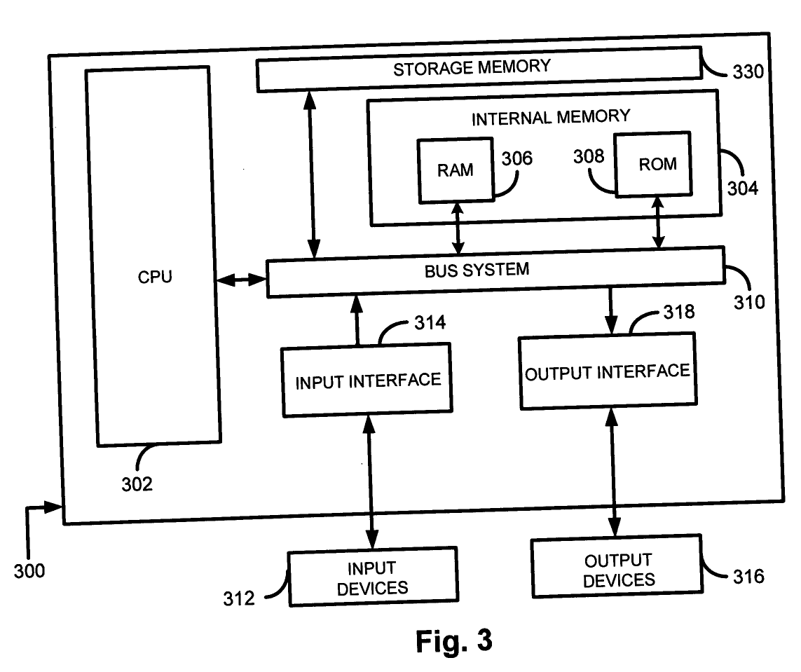

FIG. 3 displays a computer implementing the teachings of the present invention. In FIG. 3, a block diagram of computer 300 is shown. In one embodiment of the present invention, client 102, registry 104, the WSDL document 106, the database generation module (i.e., DB development tool) 108, the Web Services platform 110, and database 112 may be implemented with computer 300. A central processing unit (CPU) 302 functions as the brain of computer 300. Internal memory 304 is shown. The internal memory 304 includes short-term memory 306 and long-term memory 308. The short-term memory 306 may be Random Access Memory (RAM) or a memory cache used for staging information. The long-term memory 308 may be a Read Only Memory (ROM) or an alternative form of memory used for storing information. In one embodiment of the present invention, a short-term memory, such as RAM 306, may be a display memory and used for storing a GUI for display on a monitor. A storage memory 330, such as a hard drive, is also shown. A bus system 310 is used by computer 300 to communicate information from short-term memory 306, long-term memory 308, storage memory 330, input interface 314, output interface 318, and CPU 302. In addition, the bus system 310 may be connected to interfaces that communicate information out of computer 300 or receive information into computer 300.

Input devices, such as a joystick, a keyboard, a microphone, a communications connection, or a mouse, are shown as 312. The input devices 312 interface with the computer 300 through an input interface 314. Output devices, such as a monitor, speakers, communications connections, etc., are shown as 316. The output devices 316 communicate with the computer 300 through an output interface 318.

While the present invention is described herein with reference to illustrative embodiments for particular applications, it should be understood that the invention is not limited thereto. Those having ordinary skill in the art and access to the teachings provided herein will recognize additional modifications, applications, and embodiments within the scope thereof and additional fields in which the present invention would be of significant utility.

It is, therefore, intended by the appended claims to cover any and all such applications, modifications, and embodiments within the scope of the present invention.

What is claimed is:

1. A database creation method, comprising the steps of:
examining a Web Services Description Language schema associated with a Web Service; and
generating a database usable by the Web Service in response to examining the Web Services Description Language schema.

2. A database creation method as set forth in claim 1, wherein the Web Services Description Language schema includes at least one “type” element and the database is automatically generated in response to reviewing the at least one type element.

3. A database creation method as set forth in claim 2, further comprising the step of determining a relationship between the at least one type element and a second type element.

4. A database creation method as set forth in claim 2, further comprising the step of determining a relationship between the at least one type element and a second type element and generating database tables in response to determining a relationship between the at least one type element and the second type element.

5. A database creation method as set forth in claim 2, wherein the at least one type element further comprises a field and the method further comprises the step of naming the field.

6. A database creation method as set forth in claim 2, further comprising the step of mapping the at least one type element to a database column in the database.

7. A database creation method as set forth in claim 1, wherein the step of generating the database further comprises the step of defining a primary key for the database.

8. A database creation method as set forth in claim 1, wherein the step of generating the database further comprises the step of defining a surrogate key for the database.

9. A database creation method as set forth in claim 2, further comprising the step of defining constraints to provide integrity between the at least one type element and a second type element.

10. A database creation method as set forth in claim 1, wherein the step of generating the database further comprises the step of generating a script to generate the database.

11. A database creation method as set forth in claim 1, wherein the step of generating the database further comprises the step of generating a class to generate the database.

12. A database creation method as set forth in claim 1, wherein the step of generating the database further comprises the step of generating a class to generate an application programmer interface that is used to generate the database.

13. A database creation method as set forth in claim 1, wherein the step of generating the database further comprises the step of generating database operation statements.

14. A database creation method as set forth in claim 1, wherein the step of generating the database further comprises the step of modifying a development tool used to generate the Web Services Description Language schema.

15. A database creation method as set forth in claim 1, wherein the database creation method is performed during deployment of the Web Service.

16. A database creation method as set forth in claim 1, wherein the database creation method is performed prior to deployment of the Web Service.

17. A database creation method as set forth in claim 1, wherein the database creation method is performed prior to deployment of the Web Service and the database is populated during deployment of the Web Service.

18. A method of processing information, comprising the steps of:
identifying Web Services Description Language elements associated with a Web Service, the Web Services Description Language elements having relationships between the Web Services Description Language elements;
determining the relationships between the Web Services Description Language elements; and
generating a database in response to determining the relationships between the Web services Description Language elements.

19. A method of processing information as set forth in claim 18, wherein the Web Services Description Language elements include at least one type element.

20. A computer program product comprising a computer useable medium including a computer readable program, wherein the computer readable program when executed on a computer causes the computer to:
identify Web Services Description Language elements associated with a Web Service, the Web Services Description Language elements having relationships between the Web Services Description Language elements;
determine the relationships between the Web Services Description Language elements; and
generate a database in response to determining the relationships between the Web services Description Language elements.
